(19) United States
(12) Patent Application Publication
(10) Pub. No.: US 2013/0008248 A1
(43) Pub. Date: Jan. 10, 2013

(54) Torsion balance apparatus

(76) Inventor: Hui Peng, El Montel, CA (US)

(21) Appl. No.: 13/135,569

(22) Filed: Jul. 9, 2011

(51) Int. Cl. G01M 1/12

(52) U.S. Cl. 73/383

(57) ABSTRACT

The present invention proposes a torsion balance apparatus with high sensitivity and accuracy to measure extremely small rotation angle. The torsion balance apparatus comprises a bar which rotates and is horizontally suspended by a suspending fiber, a light source, a detector and a light reflecting system which reflects the light beam from the light source several times and reaches to the detector.

### FIELD OF THE INVENTION

The present invention relates to a torsion balance apparatuses which improves the sensitivity and accuracy for detecting extremely small forces.

### BACKGROUND OF THE INVENTION

Torsion balance apparatus have been employed in measuring extremely small forces, such as Cavendish experiment to determine the gravitational constant. One of prior torsion balance apparatuses is made of a bar vertically suspended from a fiber, with a small ball attached to each end. Two larger balls were located near each small ball respectively, a distance away, and held in place with a separate suspension system. The torsion balance apparatus measured the faint gravitational attraction between the small balls and the larger ones.

The two large balls were positioned on alternate sides of the horizontal bar of the torsion balance. Their mutual attraction to the small balls caused the bar to rotate, twisting the fiber supporting the bar. The bar stopped rotating when it reached an angle where the twisting force of the fiber balanced the combined gravitational force of attraction between the large and small balls. By measuring the angle of the rod, and knowing the twisting force (torque) of the fiber for a given angle, one is able to determine the force between the pairs of masses.

To measure the rotation angle, a laser beam, a mirror attached to the fiber and a detector (scale) are employed. The light beam of the laser shines on the mirror and reflected to the scale. The displacement of the image of the laser on the scale before and after the bar rotation is measured and shows the rotation angle of the mirror, thus the bar.

However, for an extremely small rotation angle, one needs to use long fiber, long bar, and set the detector at a distance far away from the mirror. The sensitivity and accuracy of the existing torsion balances are low. Therefore it is needed to improve a torsion balance to have higher sensitivity and accuracy.

### SUMMARY OF THE INVENTION

The present invention relates to a torsion balance apparatuses which improves the sensitivity and accuracy for detecting extremely small forces.

Embodiment 1. An optical system comprises two mirrors which are substantially parallel to each other. One of the mirrors, call it mirror 1, is attached to the suspending fiber of a torsion balance apparatus so that when the fiber turns an angle, the mirror 1 turns the same angle. Another mirror, call it mirror 2, is supported independently at a position facing and parallel to the mirror 1 and, therefore, does not rotate. A light source and a detector are positioned behind the mirror 2. The light from the light source shines on the mirror 1 at an incident angle and is reflected toward to the mirror 2 and then is reflected by the mirror 2 toward back to the mirror 1, and so on, until exits the optical system and reaches the detector. After the mirror 1 rotated an angle θ, every time the light is reflected by the mirror 2, the angle between the mirror 2 and the reflected light is decreased by 20. Therefore the image of the light source on the detector is shifted farther.

Embodiment 2. The embodiment 2 is similar to the embodiment 1 except that the mirror 1 is attached to the bar of a torsion balance apparatus so that when the bar turns an angle, the mirror 1 turns the same angle.

Embodiment 3. The embodiment 3 is similar to the embodiment 2 except that the mirror 1 is a reflective layer coated on the bar of a torsion balance apparatus so that when the bar turns an angle, the mirror 1 turns the same angle.

Embodiment 4. The embodiment 4 is similar to the embodiment 1 except that there is at least one opening on the mirror 2 to allow the light goes through it to reach the detector before the mirror 1 turns an angle so that one can record the position of the image of the light on the detector and then can compare with the position of the image of the light on the detector after the mirror turns an angle.

Embodiment 5. The embodiment 5 is similar to the embodiment 2 except that there is at least one opening on the mirror 2 to allow the light goes through it to reach the detector before the mirror 1 turns an angle.

Embodiment 6. The embodiment 6 is similar to the embodiment 3 except that there is at least one opening on the mirror 2 to allow the light goes through it to reach the detector before the mirror 1 turns an angle.

### BRIEF DESCRIPTION OF DRAWINGS

FIG. 1A is the schematic drawing of the prior art torsion balance apparatus of Cavendish experiment.

FIG. 1B is the top view of the prior art torsion balance apparatus of Peng experiment.

FIG. 1C shows the optical system of a prior art torsion balance apparatus comprising a mirror, a light source and a detector.

FIG. 2A shows the working principle of the optical system of the present invention.

FIG. 2B shows an embodiment of the optical system of the present invention.

FIG. 2C shows an embodiment of the optical system of the present invention.

FIG. 3A is the top view of an embodiment of the optical system of the present invention attached to the torsion balance of Peng experiment.

FIG. 3B is the A-A cross sectional view of FIG. 3A.

FIG. 3C is the B-B cross sectional view of FIG. 3A.

FIG. 4 shows the schematic drawing of an embodiment of the optical system of the present invention attached to the torsion balance of Cavendish experiment.

### DETAILED DESCRIPTION

In the prior art the light from a light source which is selected from a group comprising light bulb, LED and laser shines on a mirror attached to suspended fiber(s) and is reflected to a detector. For the torsion balance apparatus of Cavendish experiment, there is one fiber to suspend vertically the bar. For the torsion balance apparatus of Peng experiment, there are two fibers to suspend horizontally the bar. In order to measure a tine rotation angle of the fiber, one has to employ long and thin fiber, long bar and positioning the detector at a distance far away from the mirror. Therefore the sensitivity and accuracy of existing torsion balance apparatus are low.

An optical system working together with a torsion balance apparatus is proposed in the present invention to improve the sensitivity and accuracy of the torsion balance apparatus.

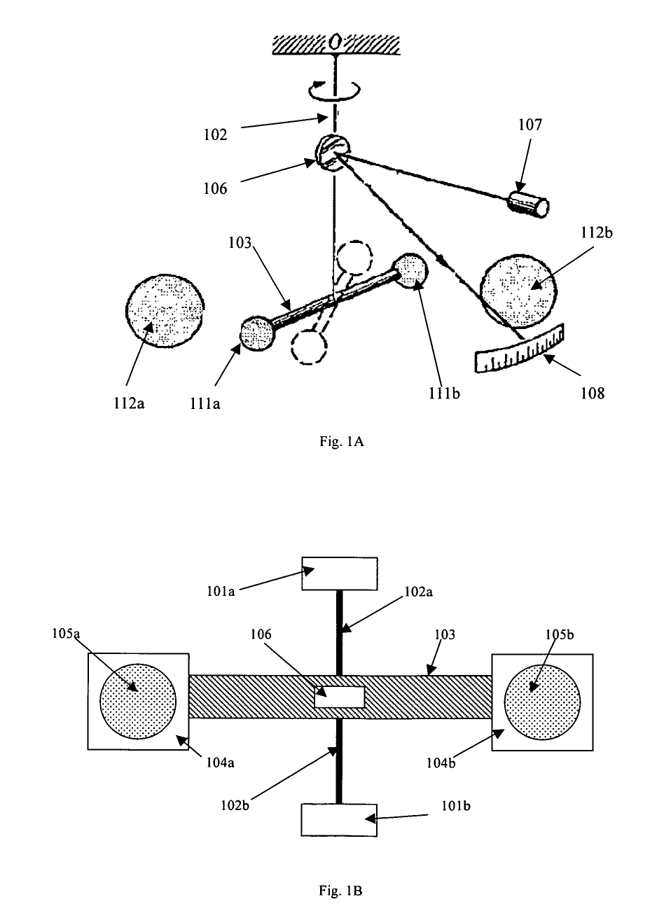

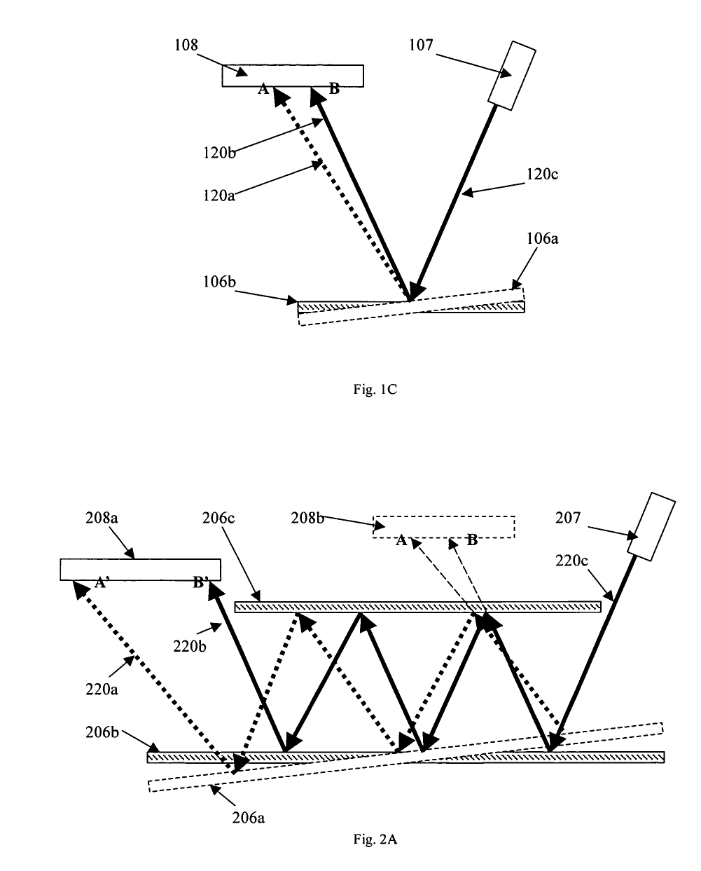

FIG. 1A shows the prior art torsion balance apparatus of Cavendish experiment. The torsion balance apparatus comprises horizontal bar 103, fiber 102 suspending bar 103 vertically, two spheres 111a and 111b attached to each end of bar 103 respectively, mirror 106 attached to fiber 102, two balls 112a and 112b located near spheres 111a and 111b respectively held in place with a separate supporting system (not shown), light source 107 and detector (scale) 108. The experiment measures the faint gravitational attraction between spheres 111a and 111b and balls 112a and 112b. Balls 112a and 112b were positioned on alternate sides of bar 103 of the balance. Their mutual attraction to spheres 111a and 111b caused bar 103 to rotate, twisting fiber 102 supporting bar 103. Bar 103 stopped rotating when it reached an angle where the twisting force of fiber 102 balanced the combined gravitational force of attraction between balls 112a and 112b and spheres 111a and 111b. By measuring the angle of bar 103, and knowing the twisting force (torque) of fiber 102 for a given angle, one is able to determine the force between the pairs of masses.

FIG. 1B shows the prior art torsion balance apparatus of Peng experiment. The torsion balance apparatus comprises horizontally bar 103, fiber 102a and fiber 102b connected to and suspending bar 103 horizontally, station 101a and station 101b supporting fiber 102a and fiber 102b respectively, housing 104a and housing 104b attached to each end of bar 103 respectively, gyro 105a and gyro 105b held in housing 104a and housing 104b respectively and rotating with opposite directions, mirror 106 attached to bar 103, light source and detector (scale) (not shown in FIG. 1B). The experiment measures the faint magnetic-type gravitational force between the Earth and both gyro 105a and gyro 105b. The magnetic-type gravitational forces cause bar 103 to rotate, twisting fiber 102a and fiber 102b. Bar 103 stopped rotating when it reached an angle where the twisting force of fiber 102a and fiber 102b balanced the combined gravitational forces. By measuring the angle of bar 103, and knowing the twisting force (torque) of fiber 102a and fiber 102b for a given angle, one is able to determine the force between the Earth and gyro 105a and gyro 105b.

FIG. 1C shows the optical system of a prior art torsion balance apparatus. The optical system comprising mirror 106b, light source 107 and detector 108. Light beam 120c from light source 107 shines on mirror 106b before mirror 106b rotating an angle, reflected by mirror 106b to become light beam 120b and reaches to point B on detector 108. After mirror turns an angle 8, denoted as mirror 106a, light beam 120c is reflected by mirror 106a to become light beam 120a and reaches to point A on detector 108. The twisting angle can be determined by the distance between points A and B.

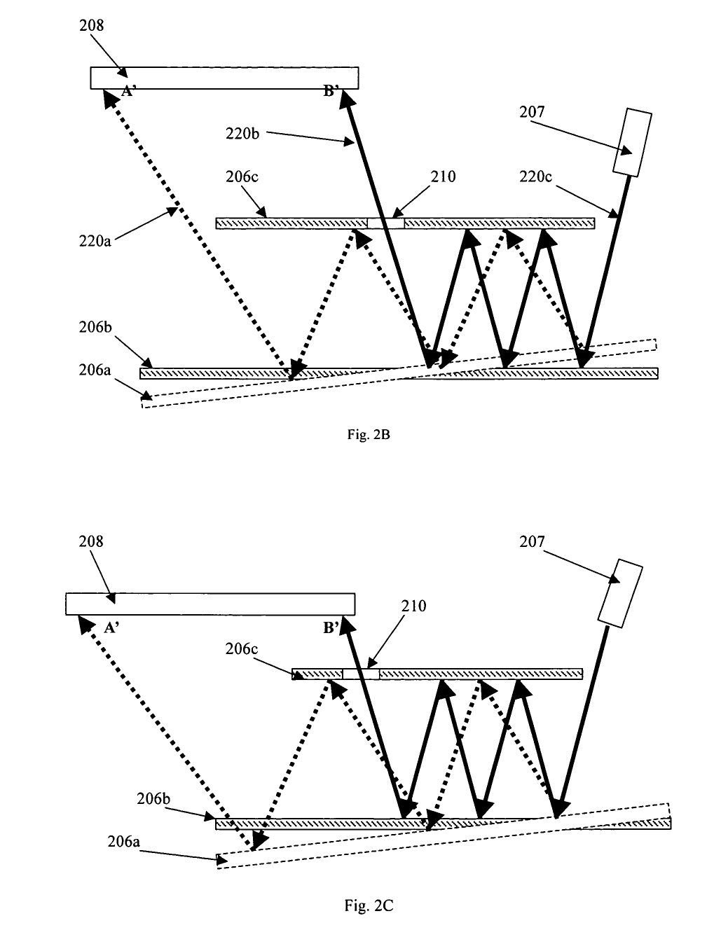

FIG. 2A shows an embodiment of the optical system of the present invention. The optical system comprises two mirrors which are substantially parallel. One of mirrors rotates and is denoted as the rotating mirror. The rotating mirror is denoted as rotating mirror 206b before rotating and denoted as rotating mirror 206a after rotating. The rotating mirror is selected from a group comprising a mirror attached to the fiber, a reflecting layer coated on the surface of the bar and a mirror attached to the bar. Another mirror is fixed at a predetermined position by a separate supporting system and is denoted as fixed mirror 206c.

Light beam 220c from light source 207 shines on rotating mirror 206b at an incident angle α before rotating mirror 206b rotating an angle, reflected by rotating mirror 206b towards to fixed mirror 206c with the same incident angle α, reflected by fixed mirror 206c towards back to rotating mirror 206b with the same incident angle α, reflected by rotating mirror 206b towards to fixed mirror 206c with the same incident angle α, then repeat the same process several times, finally reaches point B′ on detector 208a.

Then the rotating mirror 206b rotates an angle θ and is denoted as rotating mirror 206a. Light beam 220c from light source 207 shines on rotating mirror 206a at an incident angle (α+θ), reflected by rotating mirror 206a and towards to fixed mirror 206c with an incident angle (α+2θ), reflected by fixed mirror 206c and towards back to rotating mirror 206a with an incident angle (α+3θ), reflected by rotating mirror 206b towards to fixed mirror 206c with an incident angle (α+4θ), then repeat the same process several times, finally reaches point A′ on detector 208a.

Imaging a situation without fixed mirror 206c. Light beam 220c from light source 207 shines on rotating mirror 206b at an incident angle α before rotating mirror 206b rotating an angle, reflected by rotating mirror 206b towards to detector 208b and reaches at point B on detector 208b. Then the rotating mirror 206b rotates an angle and is denoted as rotating mirror 206a. Light beam 220c from light source 207 shines on rotating mirror 206a at an incident angle (α+θ), reflected by rotating mirror 206a and towards to detector 208b and reaches point A on detector 208b.

The distance between points A′ and B′ caused by fixed mirror 206c is several times larger that that of points A and B without fixed mirror 206c. Therefore the optical system of the present invention improves the sensitivity and accuracy of torsion balance apparatus by several times. The improvement is one or two even more orders depended on how many time the light beam is reflected before finally reaching a detector. The twisting angle of suspending fiber(s) can be determined by the distance between points A′ and B′.

FIG. 2B shows an embodiment of the optical system of the present invention. The optical system in FIG. 2B is similar to that shown in FIG. 2A except that there is opening 210 on fixed mirror 206c for allowing light beam 220b to go through fixed mirror 206c to reach detector 208 before rotating mirror 206b rotates an angle.

FIG. 2C shows an embodiment of the optical system of the present invention. The optical system in FIG. 2C is similar to that shown in FIG. 2B except that light beam 220c shines at a point on the rotation mirror where the rotation axis of the rotating mirror is at.

Note: In embodiments of FIG. 2A, FIG. 2B and FIG. 2C the position of point B′ on detector 208 and detector 208a is not necessary to be determined as long as the position of point A′ on detector 208 and detector 208a is determined. Therefore opening 210 in embodiments of FIG. 2B and FIG. 2C is not necessary.

The optical system of the present invention can be applied to torsion balance apparatus.

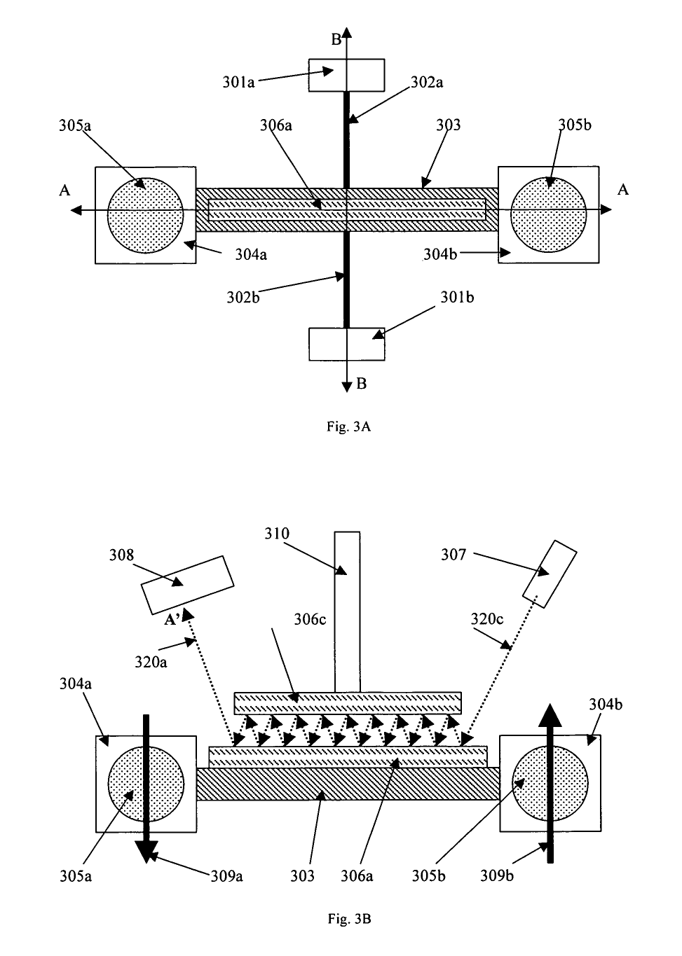

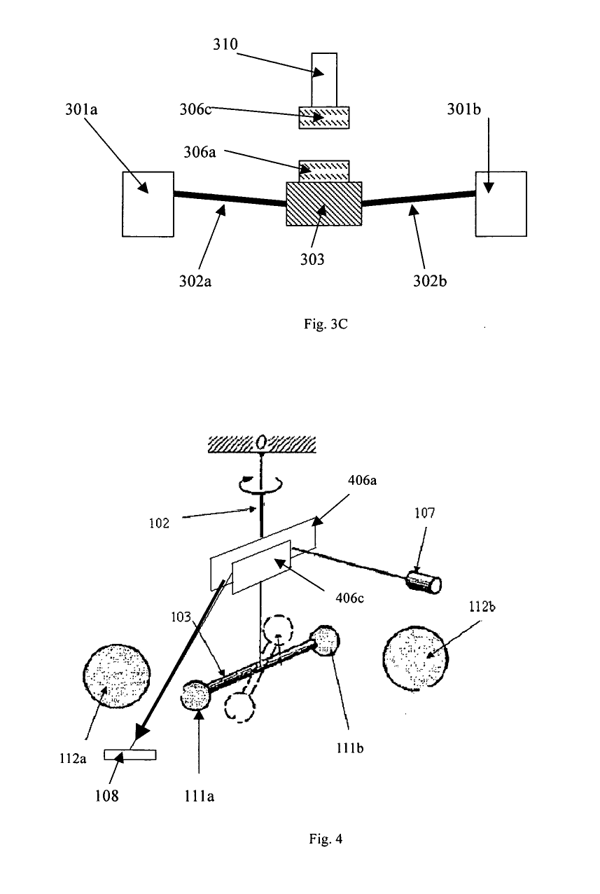

FIG. 3A, FIG. 3B and FIG. 3C are the top view, A-A cross sectional view and B-B cross sectional view of an embodiment of the optical system of the present invention attached to the torsion balance of Peng experiment. The torsion balance apparatus comprises horizontally bar 303, fiber 302a and fiber 302b connected to and suspending bar 303 horizontally, station 301a and station 301b supporting fiber 302a and fiber 302b respectively, housing 304a and housing 304b attached to each end of bar 303 respectively, gyro 305a and gyro 305b held in housing 304a and housing 304b and rotating with opposite direction 309a and direction 309b respectively, rotating mirror 306a attached to bar 303, fixed mirror 306c, support bar 310 supporting fixed mirror 306c, light source 307 and detector (scale) 308. Fixed mirror 306c is substantially parallel to rotating mirror 306a.

Light beam 320c from light source 307 shines on rotating mirror 306a, reflected to fixed mirror 306c, reflected back to rotating mirror 306a, and reflected back and forth between rotating mirror 306a and fixed mirror 306c, until turns to light beam 320a and come out the optical system and reaches point A′ on detector 308.

FIG. 4 shows the schematic drawing of an embodiment of the optical system attached to the torsion balance of Cavendish experiment.

The mirror 1 is selected from a group comprising a piece of transparent material coated with reflected material and a layer of reflected material coated on the bar, wherein the reflected materials comprising gold, silver and aluminum.

The light source is selected from a group comprising light bulb, LED and laser. The color of the light is selected from a group comprising red, green, yellow, blue, and cyan.

What is claimed is:

1. A torsion balance apparatus comprising:
a bar,
at least two housings attached to each end of said bar,
at least two gyro with mechanisms,
at least one suspending fiber suspending said bar horizontally,
two supporting stations to support fiber,
a light source,
a detector,
a light reflecting system which reflecting a light beam from said light source to said detector,
wherein each of said gyros held in a said housings respectively and rotating driven by said mechanisms respectively.

2. The torsion balance apparatus of claim 1, wherein said light reflecting system comprises a rotating mirror attached to said bar and rotating with said bar and a fixed mirror supported by a separate supporting system.

3. The torsion balance apparatus of claim 2, wherein said fixed mirror parallels substantially to said rotating mirror.

4. The torsion balance apparatus of claim 1, wherein said light reflecting system comprises a rotating mirror attached to said fiber and rotating with said fiber and a fixed mirror supported by a separate supporting system.

5. The torsion balance apparatus of claim 4, wherein said fixed mirror parallels substantially to said rotating mirror.

6. The torsion balance apparatus of claim 1, wherein said light reflecting system comprises a reflecting layer coated on said bar and a fixed mirror supported by a separate supporting system.

7. The torsion balance apparatus of claim 6, wherein said fixed mirror parallels substantially to said bar.

8. The torsion balance apparatus of claim 1, wherein said bar has a linear shape with two ends.

9. The torsion balance apparatus of claim 1, wherein said bar has a shape of reversely contacted forks with at least four fingers and said housing with said gyro in it attached to each end of said fingers.

10. The torsion balance apparatus of claim 1, wherein there are two or more said bar attached to at least one said fiber.

11. The torsion balance apparatus of claim 1, wherein said fixed mirror has at least one opening.
